(19) United States
(12) Patent Application Publication
(10) Pub. No.: US 2023/0388797 A1
(43) Pub. Date: Nov. 30, 2023

(54) METHOD OF COMMUNICATION APPARATUS, METHOD OF UE, COMMUNICATION APPARATUS, AND UE

(71) Applicant: NEC Corporation, Minato-ku, Tokyo (JP)

(72) Inventors: Kundan TIWARI, Tokyo (JP); Toshiyuki TAMURA, Tokyo (JP)

(73) Assignee: NEC Corporation, Minato-ku, Tokyo (JP)

(21) Appl. No.: 18/032,394

(22) PCT Filed: Oct. 28, 2021
(86) PCT No.: PCT/JP2021/039913

§ 371 Date: Apr. 18, 2023

(30) Foreign Application Priority Data
Oct. 29, 2020 (IN) 202011047284

(51) Int. Cl. H04W 12/06; H04W 36/00; H04W 36/14

(52) U.S. Cl. CPC H04W 12/06; H04W 36/0066; H04W 36/14

(57) ABSTRACT

This disclosure defines a procedure to handle authentication procedure during Xn handover. More specifically it defines handling of an authentication procedure when Xn handover takes place from one serving PLMN to another serving PLMN during the authentication procedure.

### TECHNICAL FIELD

The present disclosure relates generally to wireless telecommunications, and, in particular embodiments, relates to handling of an authentication procedure when Xn handover takes place from one serving PLMN to another serving PLMN during the authentication procedure.

### BACKGROUND ART

The purpose of the primary authentication and key agreement procedure is to enable mutual authentication between the UE and the network and to provide keying material that can be used between the UE and the network in subsequent security procedures, as specified in 3GPP TS 33.501 [5]. The keys K_{AUSF}, K_{SEAF} and K_{AMF} are generated after successful authentication procedure.

Two methods are defined:
a) EAP based primary authentication and key agreement procedure.
b) 5G AKA based primary authentication and key agreement procedure.

The UE and the AMF shall support the EAP based primary authentication and key agreement procedure and the 5G AKA based primary authentication and key agreement procedure. When the authentication procedure fails in the network then the AMF returns an Authentication Reject message to the UE. The serving network name is used to calculate the RES* and XRES* by the UE and the UDM respectively. If the RES* and HRES* verification is done successfully at the AUSF, the AUSF considers the authentication procedure as success. The serving network name is used in the derivation of the anchor key (K_{AUSF}). It binds the anchor key to the serving network by including the serving network identifier (SN Id). It makes sure that the anchor key is specific for authentication between a 5G core network and a UE by including a service code set to “5G”. In 5G AKA, the serving network name has a similar purpose of binding the RES* and XRES* to the serving network. The SN Id identifies the serving PLMN. For the UE point of view it is the serving network that the network is authenticating to. For the UDM it is the serving network that is sent by the AUSF.

FIG. 1 shows the initiation of authentication procedure and selection of authentication method. The SEAF may initiate an authentication with the UE during any procedure establishing a signalling connection with the UE, according to the SEAF's policy. Based on SUPI, the UDM/ARPF shall choose the authentication method.

FIG. 2 shows the Authentication procedure for 5G AKA.

On the other hand, FIG. 3 shows the Xn handover procedure. In a network deployment scenario, a Registration Area (RA) can consist of one or multiple first Tracking Areas (TAs) served by a PLMN ID=A and one or multiple second TAs served by a PLMN ID=B. When a UE in connected mode moving from a RAN that belonging to the first TAs to a RAN that belonging to the second TAs, the Xn handover procedure takes place. After the Xn handover procedure the serving network is changed from PLMN ID=A to PLMN ID=B in the UE and the network while the AMF remains the same after the Xn handover procedure.

### CITATION LIST

### Non Patent Literature

NPL 1: 3GPP TR 21.905: “Vocabulary for 3GPP Specifications”. V16.0.0 (2019June)

NPL 2: 3GPP TS 23.501: “System architecture for the 5G System (5GS)”. V16.6.0 (2020September)

NPL 3: 3GPP TS 23.502: “Procedures for the 5G System (5G″S)” V16.6.0 (2020September)

NPL 4: GPP TS 24.501: “Non-Access-Stratum (NAS) protocol for 5G System (5GS); Stage 3” V16.6.0 (2020September)

NPL 5: 3GPP TS 33.501: “Security architecture and procedures for 5G system” V16.4.0 (2020September)

NPL 6: 3GPP TS 33.102: “3G Security; Security architecture” V16.0.0 (2020July)

NPL 7: 3GPP TS 24.301: “Non-Access-Stratum (NAS) protocol for Evolved Packet System (EPS)” V16.6.0 (2020September)

NPL 8: 3GPP TS 29.272: “Mobility Management Entity (MME) and Serving GPRS Support Node (SGSN) related interfaces based on Diameter protocol” V16.4.0 (2020September)

### SUMMARY OF INVENTION

### Technical Problem

An authentication procedure can be initiated at any time by an AMF based on local policy. There can be a scenario that the Xn handover takes place from one serving PLMN to another serving PLMN during an ongoing authentication procedure. In this scenario, the UE and 5G core network (e.g. AUSF, UDM) are out of sync with regards to current serving PLMN. I.E. While the UE maintains the PLMN after the Xn handover procedure takes place, the 5G core network may maintain the PLMN before the Xn handover procedure takes place. This mismatch in the UE and 5G core network may lead to a failure in the authentication procedure and hence the user can no longer access services.

### Solution to Problem

In a first aspect of the present disclosure, a method a communication apparatus, is provided, and the method comprises: performing a registration procedure to a first Public Land Mobile Network (PLMN) for a user equipment (UE); sending a first message to perform an authentication for the UE, wherein the first message includes an identifier of the first PLMN; performing a handover procedure with a change from the first PLMN to a second PLMN for the UE; receiving a second message, wherein the second message includes the identifier of the first PLMN; and sending an authentication request message to the UE, wherein the authentication request message includes the identifier of the first PLMN.

In a second aspect of the present disclosure, a method of a user equipment (UE) is provided, and the method comprises: performing a registration procedure to a first Public Land Mobile Network (PLMN); performing a handover procedure with a change from the first PLMN to a second PLMN; receiving an authentication request message, wherein the authentication request message includes an identifier of the first PLMN; and performing an authentication procedure based on the identifier of the first PLMN.

In a third aspect of the present disclosure, a communication apparatus comprises: means for performing a registration procedure to a first Public Land Mobile Network (PLMN) for a user equipment (UE), means for sending a first message to perform an authentication for the UE, wherein the first message includes an identifier of the first PLMN; means for performing a handover procedure with a change from the first PLMN to a second PLMN for the UE; means for receiving a second message, wherein the second message includes the identifier of the first PLMN; and means for sending an authentication request message to the UE, wherein the authentication request message includes the identifier of the first PLMN.

In a fourth aspect of the present disclosure, a user equipment (UE) comprises: means for performing a registration procedure to a first Public Land Mobile Network (PLMN); means for performing a handover procedure with a change from the first PLMN to a second PLMN; means for receiving an authentication request message, wherein the authentication request message includes an identifier of the first PLMN; and means for performing an authentication procedure based on the identifier of the first PLMN.

In a fifth aspect of the present disclosure, a method of a communication apparatus is provided, and the method comprises: performing a registration procedure to a first Public Land Mobile Network (PLMN) for a user equipment (UE); sending a first message to perform an authentication for the UE, wherein the first message includes an identifier of the first PLMN; performing a handover procedure with a change from the first PLMN to a second PLMN for the UE; receiving a second message, wherein the second message includes an identifier of a second PLMN; determining whether the handover procedure occurs while the authentication using the identifier of the first PLMN is ongoing; and sending an authentication request message to the UE in a case where the handover procedure occurs while the authentication using the identifier of the first PLMN is ongoing, wherein the authentication request message includes the identifier of the first PLMN.

In a sixth aspect of the present disclosure, a communication apparatus comprises: means for performing a registration procedure to a first Public Land Mobile Network (PLMN) for a user equipment (UE); means for sending a first message to perform an authentication for the UE, wherein the first message includes an identifier of the first PLMN; means for performing a handover procedure with a change from the first PLMN to a second PLMN for the UE; means for receiving a second message, wherein the second message includes an identifier of a second PLMN; means for determining whether the handover procedure occurs while the authentication using the identifier of the first PLMN is ongoing; and means for sending an authentication request message to the UE in a case where the handover procedure occurs while the authentication using the identifier of the first PLMN is ongoing, wherein the authentication request message includes the identifier of the first PLMN.

In a seventh aspect of the present disclosure, a method of a communication apparatus is provided, and the method comprises: performing a registration procedure to a Public Land Mobile Network (PLMN) for a user equipment (UE); storing an identifier of the PLMN; and using the identifier for an authentication procedure of the UE.

In an eighth aspect of the present disclosure, a method of a user equipment (UE) is provided, and the method comprises: performing a registration procedure to a Public Land Mobile Network (PLMN); storing an identifier of the PLMN; and using the identifier for an authentication procedure of the UE.

In a ninth aspect of the present disclosure, a communication apparatus comprises: means for performing a registration procedure to a Public Land Mobile Network (PLMN) for a user equipment (UE); means for storing an identifier of the PLMN; and means for using the identifier for an authentication procedure of the UE.

In a tenth aspect of the present disclosure, a user equipment (UE) comprises: means for performing a registration procedure to a Public Land Mobile Network (PLMN); means for storing an identifier of the PLMN; and means for using the identifier for an authentication procedure of the UE.

In an eleventh aspect of the present disclosure, a method of a communication apparatus is provided, and the method comprises: performing a registration procedure to a first Public Land Mobile Network (PLMN) for a user equipment (UE); receiving a first message during a handover procedure with a change from a first PLMN to a second PLMN, wherein the first message includes an identifier of the second PLMN; and sending a second message to a Unified Data Management (UDM), wherein the second message includes the identifier of the second PLMN.

In a twelfth aspect of the present disclosure, a communication apparatus comprises: means for performing a registration procedure to a first Public Land Mobile Network (PLMN) for a user equipment (UE); means for receiving a first message during a handover procedure with a change from a first PLMN to a second PLMN, wherein the first message includes an identifier of the second PLMN; and means for sending a second message to a Unified Data Management (UDM), wherein the second message includes the identifier of the second PLMN.

In a thirteenth aspect of the present disclosure, a method of a communication apparatus is provided, and the method comprises: performing a registration procedure to a first Public Land Mobile Network (PLMN) for a user equipment (UE); sending a first message to authenticate the UE, wherein the first message includes an identifier of the first PLMN; performing a handover procedure with a change from the first PLMN to a second PLMN; determining whether the handover is performed while the authentication is ongoing; and sending a second message to authenticate the UE, wherein the second message includes an identifier of the second PLMN.

In a fourteenth aspect of the present disclosure, a communication apparatus comprises: means for performing a registration procedure to a first Public Land Mobile Network (PLMN) for a user equipment (UE); means for sending a first message to authenticate the UE, wherein the first message includes an identifier of the first PLMN; means for performing a handover procedure with a change from the first PLMN to a second PLMN; means for determining whether the handover is performed while the authentication is ongoing; and means for sending a second message to authenticate the UE, wherein the second message includes an identifier of the second PLMN.

In a fifteenth aspect of the present disclosure, a method of a communication apparatus is provided, and the method comprises: performing a registration procedure to a first Public Land Mobile Network (PLMN) for a user equipment (UE); receiving a first message during a handover procedure with a change from a first PLMN to a second PLMN, wherein the first message includes an identifier of the second PLMN; and allocating a 5G Globally Unique Temporary Identifier (5G-GUTI) based on the identifier of the second PLMN in a case where the first message is received; and sending the 5G-GUTI to the UE.

In a sixteenth aspect of the present disclosure, a communication apparatus comprises: means for performing a registration procedure to a first Public Land Mobile Network (PLMN) for a user equipment (UE); means for receiving a first message during a handover procedure with a change from a first PLMN to a second PLMN, wherein the first message includes an identifier of the second PLMN; and means for allocating a 5G Globally Unique Temporary Identifier (5G-GUTI) based on the identifier of the second PLMN in a case where the first message is received; and means for sending the 5G-GUTI to the UE.

### BRIEF DESCRIPTION OF DRAWINGS

FIG. 1 is a conventional signaling diagram illustrating initiation of authentication procedure and selection of authentication method.

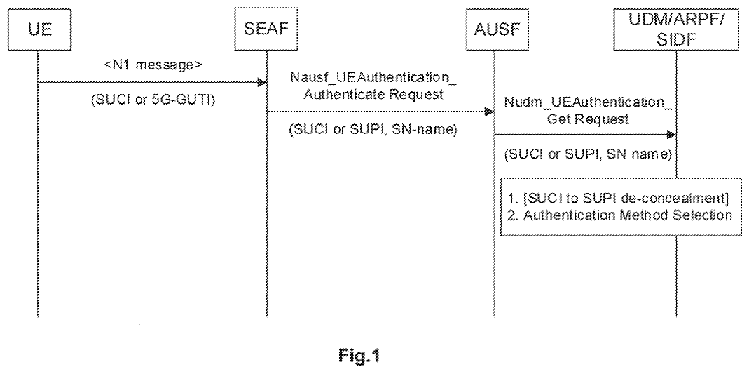

FIG. 2 is a conventional signaling diagram illustrating authentication procedure for 5G AKA.

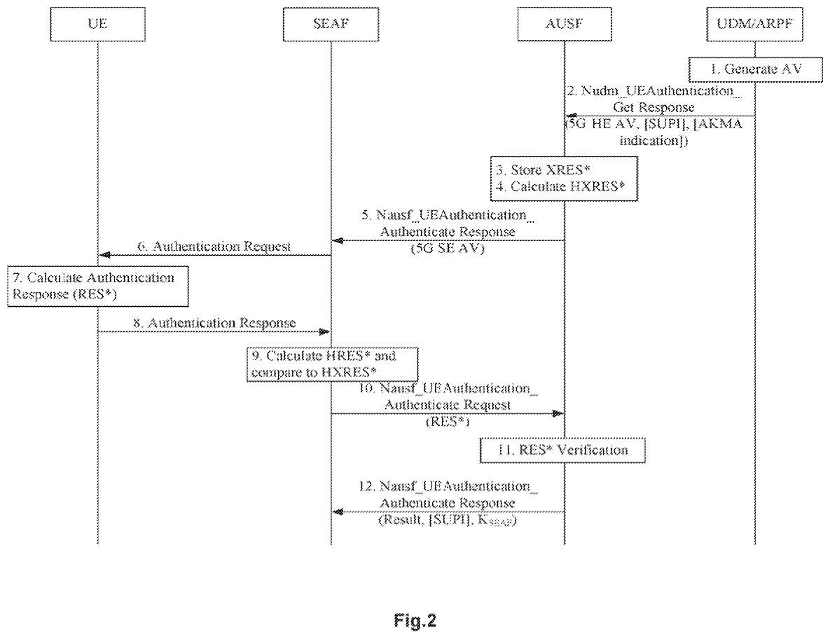

FIG. 3 is a conventional signaling diagram illustrating procedure for Xn handover.

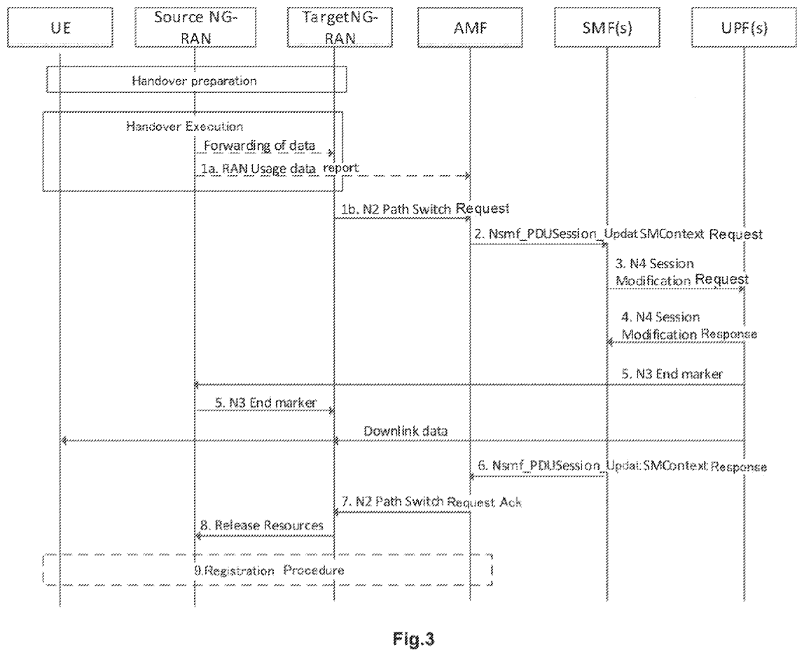

FIG. 4 illustrates an encoding of SN id as an octet string.

FIG. 5 is a signaling diagram illustrating an embodiment of procedure for handling of Authentication procedure with Xn handover.

FIG. 6 is a signaling diagram illustrating an embodiment of procedure for handling of Authentication procedure with Xn handover.

FIG. 7 is a signaling diagram illustrating an embodiment of procedure for handling of Authentication procedure during Xn handover.

FIG. 8 is a block diagram schematically illustrating a UE.

FIG. 9 is a block diagram schematically illustrating a (R)AN.

FIG. 10 is a block diagram schematically illustrating an AMF.

FIG. 11 is a diagram illustrating Authentication procedure for EAP-AKA′.

FIG. 12 is a diagram illustrating Authentication procedure for 5G AKA.

FIG. 13 is a diagram illustrating Authentication procedure for EAP-AKA′.

FIG. 14 is a diagram illustrating Authentication procedure for 5G AKA.

### DESCRIPTION OF EMBODIMENTS

The present disclosure provides a procedure to handle authentication procedure during Xn handover. More specifically it defines handling of an authentication procedure when Xn handover takes place from one serving PLMN to another serving PLMN during the authentication procedure.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope.

The disclosure will be described and explained with additional specificity and detail with the appended figures.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

### General

The service network is explained in this section.

### Serving Network Name

The serving network name is used in the derivation of the anchor key. It serves a dual purpose, namely:
It binds the anchor key to the serving network by including the serving network identifier (SN Id).
It makes sure that the anchor key is specific for authentication between a 5G core 5 network and a UE by including a service code set to “5G”.

In the 5G AKA based primary authentication and key agreement procedure, the serving network name has a similar purpose of binding the RES* and XRES* to the serving network. The serving network name is the concatenation of the service code and the SN Id with a separation character “:” such that the service code prepends the SN Id.

NOTE: No parameter like ‘access network type’ is used for serving network name as it relates to a 5G core procedure that is access network agnostic. The SN Id identifies the serving PLMN and, except for standalone non-public networks, is defined as SNN-network-identifier in 3GPP TS 24.501 [4].

### Construction of the Serving Network Name by the UE

The UE shall construct the serving network name as follows:
It shall set the service code to “5G”.
It shall set the network identifier to the SN Id of the network that it is authenticating to.
Concatenate the service code and the SN Id with the separation character “:”.

### Construction of the Serving Network Name by the SEAF

The SEAF shall construct the serving network name as follows:
It shall set the service code to “5G”.
It shall set the network identifier to the SN Id of the serving network to which the authentication data is sent by the AUSF.
It shall concatenate the service code and the SN Id with the separation character “:”.

Note that the AUSF gets the serving network name from the SEAF. Before using the serving network name, AUSF checks that the SEAF is authorized to use it.

All the embodiments are also applicable to the EAP based primary authentication and agreement procedure.

In this disclosure, the primary “authentication and key agreement procedure” implies to either “the EAP based primary authentication and agreement procedure” or “the 5G AKA based primary authentication and key agreement procedure”, unless otherwise stated.

In this disclosure, the term “authentication procedure” implies to either “the EAP based primary authentication and agreement procedure” or “the 5G AKA based primary authentication and key agreement procedure”, unless otherwise stated.

In this disclosure, the term AMF can be interpreted as SEAF. The term KAUSF can be interpreted as Kausf or K_{AUSF}. The term KSEAF can be interpreted as K_{SEAF}. The term KAMF can be interpreted as K_{AMF}. The following embodiments are not limited to 5GS, and the following embodiments are also applicable to communication system other than 5GS e.g. EPS AKA.

In case that following embodiments apply to the EPS, the following replacements are required:

### Replacements of Procedure

“the 5G AKA based primary authentication and key agreement procedure” shall be replaced with “EPS AKA procedure”.
“Xn handover procedure” shall be replaced with “X2-based handover procedure”.

### Replacements of Node Name

AMF and SEAF shall be replaced with MME.
UDM and ARPF shall be replaced with HSS.
AUSF can be replaced with HSS.

### Replacements of Message

Registration Request message can be replaced with either Attach Request message or Tracking Area Update message.
N2 Path Switch Request shall be replaced with Path Switch Request message.
Nausf_UEAuthentication_Authenticate Request message can be replaced with Authentication Information Request message as defined in the 3GPP TS 29.272 [8].
Nudm_UEAuthentication_Get Request message can be replaced with Authentication Information Request message as defined in the 3GPP TS 29.272 [8].
A combination of Nausf_UEAuthentication_Authenticate Request message and Nudm_UEAuthentication_Get Request message can be replaced with Authentication. Information Request message as defined in the 3GPP TS 29.272 [8].
Nudm_Authentication_Get Response message can be replaced with Authentication Information Answer message as defined in the 3GPP TS 29.272 [8].
Nausf_UEAuthentication_Authenticate Response can be replaced with Authentication Information Answer message as defined in the 3GPP TS 29.272 [8].
A combination of Nudm_Authentication_Get Response message and Nausf_UEAuthentication_Authenticate Response can be replaced with Authentication Information Answer message as defined in the 3GPP TS 29.272 [8].

### Replacements of Parameter

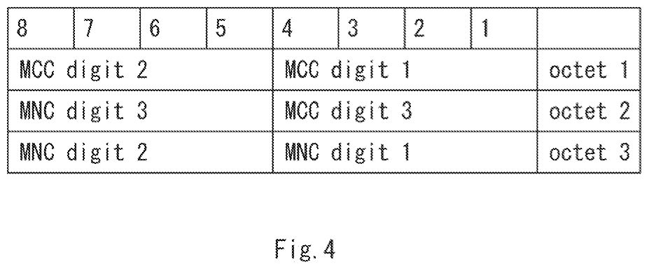

SUCI and SUPI can be replaced with IMSI.
5G-GUTI shall be replaced with GUTI or 4G-GUTI.
ngKSI shall be replaced with KSI.
Serving Network Name is replaced with Serving Network Identity which is described in FIG. 4. The Serving Network identity (SN-Id) is used to derive the KASME in the UE and MME. The coding of the digits of MCC and MNC are defined in the 3GPP TS 24.301 [7].

Note that, other than the above example, the procedure, the node name, the message, and the parameter in 5GS also can be replaced with the corresponding procedure, the corresponding node name, the corresponding message, and the corresponding parameter in EPS respectively.

In the embodiments below, the UE calculates two K_{AUSF}, first K_{AUSF} based on PLMN ID=A and second K_{AUSF} based on PLMN ID=B. The UE uses the first K_{AUSF} in the security procedure, if the security procedure using the first K_{AUSF} fails then the UE uses the second K_{AUSF} in the security procedure and deletes the first K_{AUSF} otherwise the UE deletes the second K_{AUSF}. The same method is applied in case of EPS to calculate and use K_{ASME}.

Unless otherwise defined, all technical and scientific terms used herein have the same meaning as commonly understood by those skilled in the art to which this disclosure belongs. The system, methods, and examples provided herein are only illustrative and not intended to be limiting.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the embodiments disclosed herein in addition to, or instead of, a system, and all such embodiments are contemplated as within the scope of the present disclosure.

### First Example Embodiment (Solution 1)

The network will send a serving network name to the UE in an Authentication Request message to use the serving network name to calculate the security parameter (e.g. RES* or Anchor Key (e.g. KAUSF)).

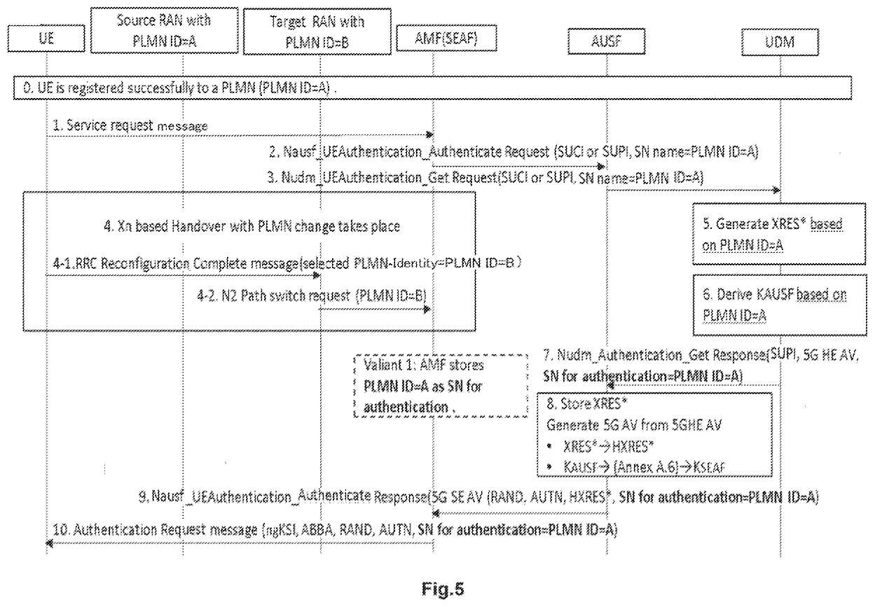

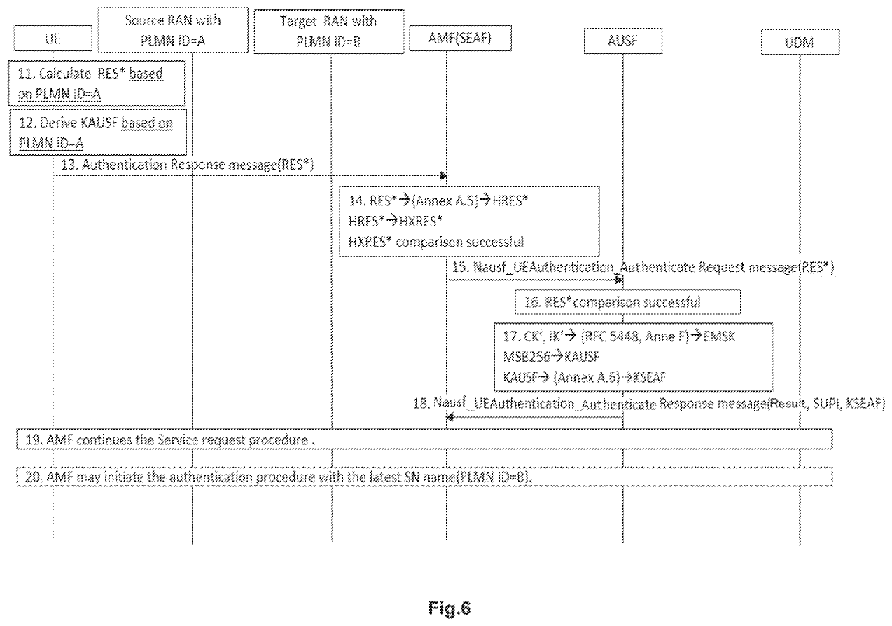

The FIGS. 5 and 6 explain the Handling of Authentication procedure when the Xn handover with PLMN change takes place during the authentication procedure. In the 5G AKA based primary authentication and key agreement procedure, the serving network name has a similar purpose of binding the RES* and XRES* to the serving network.

Note that the FIG. 6 is a continuation from the bottom of the FIG. 5.

The detailed processes of the embodiment are described as below.
0. A UE and a network (e.g., RAN, an AMF and so on) perform a registration procedure. And then the UE is registered to a PLMN with PLMN ID=A. A PLMN ID is an identifier (or an identity) identifies a PLMN. “PLMN ID =A” means that a PLMN ID is “A” or that a PLMN ID is set to “A”. That is, the UE is registered to the PLMN identified by the PLMN ID which is “A”. The registration area consists of at least two Tracking Areas (TA1 served by PLMN ID=A and TA2 served by PLMN ID=B). “PLMN ID=B” means that a PLMN ID is “B” or that a PLMN ID is set to “B”. This registration area is assigned to the UE during the registration procedure.
1. The UE initiates service request procedure. The UE establishes an RRC connection on a cell of PLMN ID=A. After the RRC connection establishment, the UE sends a Service request message to the AMF.

Note that the Service request message in step 1 can be any NAS message.
2. The AMF receives the Service request message from the UE. Then, the AMF may initiate the Authentication procedure for the UE (e.g. due to local policy) by sending the Nausf_UEAuthentication_Authenticate Request (SUPI, SN name=PLMN ID=A) to the AUSF. “SN name=PLMN ID=A” means that the SN name is a PLMN ID which is “A” or that the SN name is a PLMN ID which is set to “A”. In other words, “SN name=PLMN ID=A” means the SN name identifies a PLMN identified by a PLMN ID which is “A”, or a PLMN with a PLMN ID which is “A”. That is, the AMF informs, to the AUSF, that the SN name is a PLMN ID which is “A”.
3. The AUSF, upon reception of the Nausf_UEAuthentication_Authenticate Request message, sends Nudm_UEAuthentication_Get Request(SUCI or SUPI, SN name=PLMN ID=A) to the UDM. That is, the AUSF informs, to the UDM, that the SN name is a PLMN ID which is “A”.
4. The Xn handover procedure is triggered in the network and the UE is handed over to a cell served by the PLMN ID=B in TA2. For example, the Xn handover may be triggered when the UE moves from TA1 to TA2.
4-1. During the Xn handover procedure, the UE sends an RRC message (for example, a RRC Reconfiguration Complete message) to the target RAN including PLMN ID=B as the selected PLMN-Identity. For example, the UE selects PLMN ID=B as the selected PLMN-Identity before sending an RRC message (for example, the RRC Reconfiguration Complete message).
4-2. During the Xn handover procedure, the Target RAN (for example, a Target gNB) sends, to the AMF, an N2 Path switch request message including (or containing) PLMN ID=B (that is, the N2 Path switch request message includes the PLMN ID which is “B”). For example, the PLMN ID is included in the E-UTRA CGI parameter that is included in the User Location Information parameter.
5. On receiving the Nudm_UEAuthentication_Get Request message the UDM generates (or calculates) XRES* based on the serving PLMN name PLMN ID=A. That is, the UDM generates XRES* based on the PLMN ID which is “A”.
6. The UDM derives (or calculates) KAUSF based on the serving PLMN name PLMN ID=A. That is, the UDM derives KAUSF based on the PLMN ID which is “A”.
7. The UDM sends Nudm_Authentication_Get Response (SUPI, 5G HE AV, SN for authentication=PLMN ID=A) to the AUSF. The Serving Network (SN) for authentication=PLMN ID=A is an optional parameter. “The SN for authentication=PLMN ID=A” means that the SN for authentication is a PLMN ID which is “A” or that the SN for authentication is a PLMN ID which is set to “A”. That is, the SN for authentication indicates that the PLMN ID to be used in the authentication procedure (for example, the SN for authentication indicates that the PLMN ID to be used for calculating RES* by the UE and deriving KAUSF by the UE).
8. The AUSF stores XRES*. The AUSF generates 5G AV from 5GHE AV, HXRES* from XRES* and KSEAF from KAUSF.
9. The AUSF sends Nausf_UEAuthentication_Authenticate Response (5G SE AV (RAND, AUTN, HXRES*, SN for authentication=PLMN ID=A) to the AMF. The Serving Network (SN) for authentication is an optional parameter. The AUSF may send Serving Network (SN) for authentication when it is received from the UDM.
10. Upon reception of the Nausf_UEAuthentication_Authenticate Response, the AMF sends an Authentication Request message containing (ngKSI, ABBA, RAND, AUTN and SN for authentication=PLMN ID=A). The SN for authentication is the SN name which is sent to the AUSF by the AMF in step 2. In one example SN for authentication is same as the one received from the AUSF in the Nausf_UEAuthentication_Authenticate Response message in step 9.
11. Upon reception of the Authentication Request message by the UE, The UE verifies AUTN. After the successful AUTN verification, the UE calculates (or generates) RES* using the SN for authentication=PLMN ID=A. That is, the UE calculates RES* based on the PLMN ID which is “A”.
12. The UE derives (or generates) KAUSF using the SN for authentication=PLMN ID=A. That is, the UE derives KAUSF based on the PLMN ID which is “A”. The UE stores the KAUSF and uses the KAUSF in a case where it is required in the security procedures (e.g. in the derivation of security keys KSEAF).
13. The UE sends an authentication response message containing RES* to the AMF.
14. Upon reception of the authentication response message from the UE, the AMF derives HRES* from RES* and compare HRES* with HXRES*.
15. On successful comparison the AMF sends the Nausf_UEAuthentication_Authenticate Request message containing RES* to the AUSF.
16. Upon reception of the Nausf_UEAuthentication_Authenticate Request message containing RES*, the AUSF compares RES* and XRES*.
17. Upon successful comparison, KSEAF is calculated from the KAUSF in the AUSF.
18. The AUSF sends Nausf_UEAuthentication_Authenticate Response message containing Result, SUPI, and KSEAF to the AMF. The Result contains the result of the authentication procedure based on the comparison of the RES* and XRES* in the AUSF. That is, the Results may be information indicating the result of the authentication procedure based on the comparison of the RES* and XRES* in the AUSF.
19. Upon reception of the Nausf_UEAuthentication_Authenticate Response message, the AMF checks the Result (for example, the AMF checks information element (IE) indicating the Results). If the Result indicates that the authentication is successful, then the AMF continues with the service request procedure that is triggered by step 1.
20. The AMF may initiate a new authentication procedure to the AUSF by sending PLMN ID=B in the Nausf_UEAuthentication_Authenticate Response message according to the procedure described in the 3GPP TS 33.501 [5]. After the successful completion of the authentication procedure, the UE and the UDM/AUSF will be synchronized with the same KAUSF created during the new authentication procedure. For example, the UE and the UDM/AUSF will be synchronized with the same KAUSF created based on the PLMN ID=B (that is, PLMN ID which is “B”).

In one example, in step 1 the UE is in a connected mode and has at least on user plane bearer (Dedicated Radio Bearer) established. The AMF decides to perform authentication procedure as per the local policy. In this case the authentication procedure is started independent of receiving a NAS message from the UE.

### Variant 1 of the Solution 1

In one example, when the AMF receives the N2 Path switch request message from the Target RAN with PLMN ID=B, the AMF can understand that while the latest PLMN ID=B, the Authentication procedure initiated in step 2 is associated with PLMN ID=A. For example, the AMF can determine and understand whether the Xn handover with a PLMN change occurs while the authentication procedure is ongoing based on sending the Nausf_UEAuthentication_Authenticate Request in step 2 and receiving the N2 Path switch request message from the Target RAN with PLMN ID=B in step 4-2. I.E. the AMF understands the mismatch of the PLMN ID, one is the latest and the other one that is used for the Authentication procedure. In this case, the AMF memorizes this mismatch and sets the PLMN ID=A to the SN for authentication when the AMF sends the Authentication Request message to the UE in step 10. And then, the AMF sends the Authentication Request message which contains the SN for authentication indicating the PLMN ID which is set to “A”. In this example, neither the UDM nor the AUSF have to deal with the SN for authentication.

### Variant 2 of the Solution 1

In step 0, when the UE is registered first time to the AMF, the UE and the AMF store the serving PLMN ID to which the UE is registered. This serving PLMN ID will be stored as the SN for authentication in the UE and AMF while the UE is registered with the AMF. The UE and the AMF may update the SN for authentication when the UE is registered to a different registration area but served with the same AMF. The UE and AMF use the SN name based on this SN for authentication in the subsequent authentication procedure triggered by the AMF. In this embodiment, the SN for authentication is PLMN ID=A which is used by the UE and the AMF in the authentication procedure from step 2 to step 18. Note that this variant 2 does not require the SN for authentication parameter in step 7, 9 and 10.

### Variant 3 of the Solution 1

In one example, regardless of whether or not the UE authentication procedure is ongoing, the AMF sends a message containing the new serving PLMN ID=B to the UDM during a Xn handover procedure with PLMN change or after the successful Xn handover procedure with PLMN change takes place. For example, the AMF may send, to the UDM, a message which contains information indicating that the new serving PLMN ID is “B” when the AMF receives the N2 Path switch request message containing a PLMN ID set to “B” during the Xn handover procedure with PLMN change. In addition, for example, the AMF may send, to the UDM, a message which contains information indicating that the new serving PLMN ID is “B” after the AMF sends a N2 Path switch request ack (acknowledgement) message in response to receive the N2 Path switch request message containing a PLMN ID set to “B”. Upon reception of the message the UDM updates the current serving PLMN of the UE to PLMN ID=B. The UDM may take some action when the serving PLMN of the UE changes to PLMN ID=B. That is, the UDM updates the serving PLMN ID of the UE to PLMN ID which is “B”. For example, the UDM may trigger the Steering of Roaming (SoR) procedure to towards the UE to send new preferred PLMN list to the UE or UE Parameter Update (UPU) procedure.

### Variant 4 of the Solution 1

In one example, after the authentication procedure is completed successfully (after step 18), the AMF sends, to the UDM, a message (e.g. Nudm_UECM_Registration service) containing PLMN ID=B to update the UDM with new serving PLMN of the UE. That is, the AMF sends, to the UDM, a message which contains information indicating that the new serving PLMN ID is “B”. Upon reception of this message the UDM updates the serving PLMN ID of the UE to PLMN ID=B. That is, the UDM updates the serving PLMN ID of the UE to PLMN ID which is “B”.

### Variant 5 of the Solution 1

In one example, when the UE receives the Authentication Request message from the AMF in step 10, the UE checks whether the MCC and MNC parts of the latest PLMN ID (for example, PLMN ID =B) that is sent in the RRC message (for example, the RRC Reconfiguration Complete message) to the target RAN in step 4-1 are the same as the MCC and MNC parts of 5G-GUTI if the UE has a valid 5G-GUTI. If the MCC and MNC parts are not the same, the UE constructs a Serving network name (that is, an SN for authentication) using the MCC and MNC parts of 5G-GUTI according to the 3GPP TS 33.501 [5] and performs, by using the Serving network name constructed based on the MCC and MNC parts of 5G-GUTI, calculation (or generation) for a RES* in step 11 and performs, by using the Serving network name constructed based on the MCC and MNC parts of 5G-GUTI, derivation (or generation) for a KAUSF in step 12.

### Variant 6 of the Solution 1

In one example, when the UE receives the Authentication Request message from the MME in step 10 for the EPS AKA procedure in the EPS, the UE checks whether the MCC and MNC parts of the latest PLMN ID (for example, PLMN ID=B) that is sent in the RRC message (for example, the RRC Connection Reconfiguration Complete message) to the target RAN in step 4-1 are the same as the MCC and MNC parts of 4G-GUTI if the UE has a valid 4G-GUTI. If the MCC and MNC parts are not the same, the UE constructs a Serving Network Identity (that is, an SN for authentication) using the MCC and MNC parts of 4G-GUTI as illustrated in the FIG. 4 and performs, by using the Serving Network Identity constructed based on the MCC and MNC parts of 4G-GUTI, calculation (or generation) for a RES* in step 11 and performs, by using the Serving Network Identity constructed based on the MCC and MNC parts of 4G-GUTI, derivation (or generation) for a KASME in step 12.

### Variant 7 of the Solution 1

In one example, when the AMF receives the Nausf_UEAuthentication_Authenticate Response message from the AUSF in step 9, the AMF checks whether the MCC and MNC parts of the latest PLMN ID (for example, PLMN ID=B) that is received in the N2 Path switch request message in step 4-2 are the same as the MCC and MNC parts of 5G-GUTI if the AMF has a valid 5G-GUTI. If the MCC and MNC parts are not the same, the AMF sends the Nausf_UEAuthentication_Authenticate Request message (SUCI or SUPI, SN name=PLMN ID=B) to the AUSF for starting a new authentication procedure with SN name=PLMN ID=B. “SN name=PLMN ID=B” means that the SN name is a PLMN ID which is “B” or that the SN name is a PLMN ID which is set to “B”. In other words, “SN name=PLMN ID=B” means the SN name identifies a PLMN identified by a PLMN ID which is “B”, or a PLMN with a PLMN ID which is “B”. That is, the AMF informs, to the AUSF, that the SN name is a PLMN ID which is “B”.

The AMF does not proceed with authentication procedure started in the step 2. I.E. The AMF aborts the authentication procedure started in the step 2.

### Variant 8 of the Solution 1

In one example, when the MME receives the Authentication Information Answer message from the HSS in step 9 or a combination of step 7 and step 9, the MME checks whether the MCC and MNC parts of the latest PLMN ID that is received in the Path switch request message in step 4-2 are the same as the MCC and MNC parts of 4G-GUTI if the MME has a valid 4G-GUTI. If the MCC and MNC parts are not the same, the MME sends the Authentication Information Request message (IMSI, SN id=PLMN ID=B) to the HSS for starting a new authentication procedure with SN id=PLMN ID=B. “SN id=PLMN ID=B” means that the SN id is a PLMN ID which is “B” or that the SN id is a PLMN ID which is set to “B”. In other words, “SN id=PLMN ID=B” means the SN id identifies a PLMN identified by a PLMN ID which is “B”, or a PLMN with a PLMN ID which is “B”. That is, the MME informs, to the HSS, that the SN id is a PLMN ID which is “B”.

The MME does not proceed with authentication procedure started in the step 2. I.E. The MME aborts the authentication procedure started in the step 2.

### Second Example Embodiment (Solution 2)

If the AMF detects that 1) Authentication is ongoing, 2) Xn handover with PLMN change has taken place, then the AMF initiate authentication procedure.

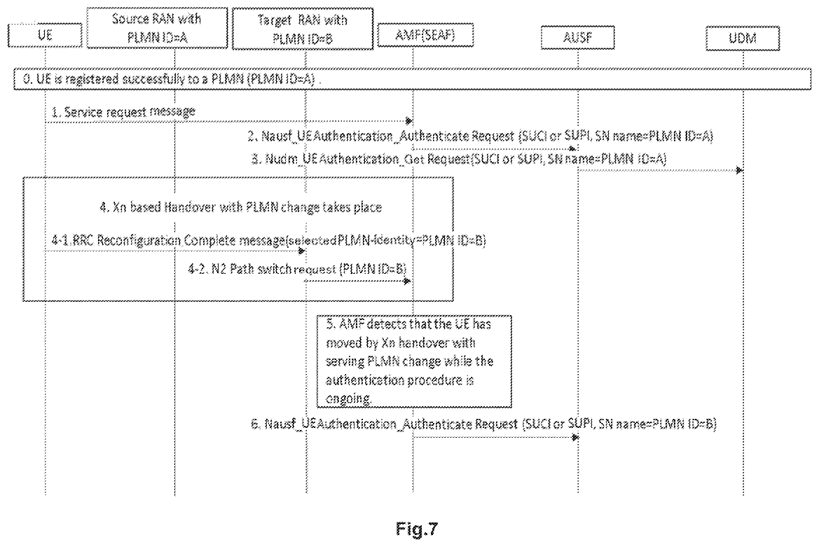

The FIG. 7 explains the Handling of Authentication procedure during Xn handover.

The detailed processes of the embodiment are described as below.
0. A UE and a network (e.g., RAN, an AMF and so on) perform a registration procedure. And then the UE is registered to a PLMN with PLMN ID=A. “PLMN ID=A” means that a PLMN ID is “A” or that a PLMN ID is set to “A”. That is, the UE is registered to the PLMN identified by the PLMN ID which is “A”. The registration area consists of at least two Tracking Areas (TA1 served by PLMN ID=A and TA2 served by PLMN ID=B). “PLMN ID=B” means that a PLMN ID is “B” or that a PLMN ID is set to “B”. This registration area is assigned to the UE during the registration procedure.
1. The UE initiates service request procedure. The UE establishes an RRC connection on a cell of PLMN ID=A. After the RRC connection establishment, the UE sends the Service request message to the AMF.

Note that the Service request message in step 1 can be any NAS message.
2. The AMF receives the Service request message from the UE. Then, the AMF may initiate the Authentication procedure for the UE (e.g. due to local policy) by sending the Nausf_UEAuthentication_Authenticate Request (SUPI, SN name=PLMN ID=A) to the AUSF. “SN name=PLMN ID=A” means that the SN name is a PLMN ID which is “A” or that the SN name is a PLMN ID which is set to “A”. That is, the AMF informs, to the AUSF, that the SN name is a PLMN ID which is “A”.
3. The AUSF, upon reception of the Nausf_UEAuthentication_Authenticate Request message, sends Nudm_UEAuthentication_Get Request(SUCI or SUPI, SN name=PLMN ID=A) to the UDM. That is, the AUSF informs, to the UDM, that the SN name is a PLMN ID which is “A”.
4. The Xn handover procedure is triggered in the network and the UE is handed over to a cell served by the PLMN ID=B in TA2. For example, the Xn handover may be triggered when the UE moves from TA1 to TA2.
4-1. During the Xn handover procedure, the UE sends an RRC message (for example, the RRC Reconfiguration Complete message) to the target RAN including PLMN ID=B as the selected PLMN-Identity. For example, the UE selects PLMN ID=B as the selected PLMN-Identity before sending an RRC message (for example, the RRC Reconfiguration Complete message).
4-2. During the Xn handover procedure, the Target RAN (for example, a Target gNB) sends, to the AMF, the N2 Path switch request message including (or containing) PLMN ID-B (that is, the N2 Path switch request message includes the PLMN ID which is “B”). For example, the PLMN ID is included in the E-UTRA CGI parameter that is included in the User Location Information parameter.
5. When the AMF detects, while the authentication procedure is ongoing, that the UE has moved to a PLMN identified by the PLMN ID=B by the Xn handover with PLMN change, then the AMF initiates a new authentication procedure toward the AUSF/UDM using SN name=PLMN ID=B. For example, the AMF may detect (or may determine) that the UE has moved to the PLMN identified by PLMN ID which is “B” by receiving the N2 Path switch request message containing a PLMN ID set to “B” in step 4-2 during the authentication procedure which is started in step 2. In addition, for example, the AMF may detect (or may determine) that the UE has moved to the PLMN identified by PLMN ID which is “B” by sending the N2 Path switch request ack (acknowledgement) message in response to receive the N2 Path switch request message containing a PLMN ID set to “B” in step 4-2 during the authentication procedure which is started in step 2. Further, for example, the AMF may detect (or may determine) that the Xn handover with a PLMN change occurs while the authentication procedure is ongoing based on sending the Nausf_UEAuthentication_Authenticate Request in step 2 and receiving the N2 Path switch request message from the Target RAN with PLMN ID=B in step 4-2, and then the AMF may initiate a new authentication procedure toward the AUSF/UDM using SN name=PLMN ID=B.
6. The AMF sends the Nausf_UEAuthentication_Authenticate Request message (SUCI or SUPI, SN name=PLMN ID=B) to the AUSF for starting a new authentication procedure with SN name=PLMN ID=B. “SN name=PLMN ID=B” means that the SN name is a PLMN ID which is “B” or that the SN name is a PLMN ID which is set to “B”. In other words, “SN name=PLMN ID=B” means the SN name identifies a PLMN identified by a PLMN ID which is “B”, or a PLMN with a PLMN ID which is “B”. That is, the AMF informs, to the AUSF, that the SN name is a PLMN ID which is “B”.

The AMF does not proceed with authentication procedure started in the step 2. I.E. The AMF aborts the authentication procedure started in the step 2.

In one example, the AMF will start the new authentication procedure when the AMF receives a response message (e.g. Nausf_UEAuthentication_Authenticate Response) from the AUSF as a response to the

Nausf_UEAuthentication_Authenticate Request (SUCI or SUPI, SN name=PLMN ID=A) message in step 2. In this case, the AMF will ignore and discard the Nausf_UEAuthentication_Authenticate Response message as a response to the Nausf_UEAuthentication_Authenticate Request (SUCI or SUPI, SN name=PLMN ID=A) message in step 2.

After step 6, the new authentication procedure based on the SN name=PLMN ID=B (that is, the PLMN ID which is “B”) proceeds between the UE and the network.

### Variant 1 of the Solution 2

In one example, in step 5, when the AMF determines that serving PLMN has changed to PLMN ID=B when it receives the N2 PATH SWITCH REQUEST message, then after completion of the Xn handover procedure, the AMF allocates new 5G-GUTI based on the PLMN ID=B, (i.e. the MCC and MNC part of PLMN ID=B is allocated to MCC and MNC of the 5G-GUTI). For example, the AMF allocates new 5G-GUTI based on the PLMN ID=B after sending the N2 Path switch request ack (acknowledgement) message. Then the AMF sends the new 5G-GUTI to the UE in a CONFIGURATION UPDATE COMMAND message and after receiving the CONFIGURATION UPDATE COMPLETE message the AMF initiates a new authentication procedure by sending a Nausf_UEAuthentication_Authenticate Request message (SUCI or SUPI, SN name=PLMN ID=B) to the AUSF. The UE uses the MCC and MNC part of the GUTI to calculate the SN name for the calculation of K_{AUSF} and RES* when the UE receives Authentication Request message after completion of the generic UE configuration update command procedure.

### Variant 2 of the Solution 2

In one example, in step 5, when the MME determines that serving PLMN has changed to PLMN ID=B when it receives PATH SWITCH REQUEST message, then after completion of the X2 handover procedure, the MME allocates a new 4G-GUTI based on the PLMN ID=B, (i.e. the MCC and MNC part of PLMN ID=B is allocated to MCC and MNC of the 4G-GUTI). For example, the MME allocates new 4G-GUTI based on the PLMN ID=B after sending the Path switch request ack (acknowledgement) message. Then the MME sends the new 4G-GUTI to the UE in a GUTI reallocation command message and after receiving the GUTI reallocation complete message the AMF initiates a new authentication procedure by sending an authentication data request containing SN ID based on the PLMN ID=B to the HSS. The UE uses the MCC and MNC part of the 4G-GUTI to calculate the SN ID for the calculation of K_{ASME} when it receives Authentication

Request message after completion of the GUTI-reallocation procedure.

### Variant 3 of the Solution 2

In one example, regardless of whether or not the UE authentication procedure is ongoing, when the AMF determines that serving PLMN has changed to PLMN ID=B when it receives the N2 PATH SWITCH REQUEST message, after completion of the Xn handover procedure, the AMF allocates new 5G-GUTI based on the PLMN ID=B, (i.e. the MCC and MNC part of PLMN ID=B is allocated to MCC and MNC of the 5G-GUTI). For example, the AMF allocates new 5G-GUTI based on the PLMN ID=B after sending the N2 Path switch request ack (acknowledgement) message. Then the AMF sends the new 5G-GUTI to the UE in the CONFIGURATION UPDATE COMMAND message in order to synchronize the latest PLMN ID and a 5G-GUTI that is associated with the latest PLMN ID.

### Variant 4 of the Solution 2

In one example, regardless of whether or not the UE authentication procedure is ongoing, when the MME determines that serving PLMN has changed to PLMN ID=B when it receives the PATH SWITCH REQUEST message, after completion of the X2 handover procedure, the MME allocates new 4G-GUTI based on the PLMN ID=B, (i.e. the MCC and MNC part of PLMN ID=B is allocated to MCC and MNC of the 4G-GUTI). For example, the MME allocates new 4G-GUTI based on the PLMN ID=B after sending the Path switch request ack (acknowledgement) message. Then the MME sends the new 4G-GUTI to the UE in the GUTI reallocation command message in order to synchronize the latest PLMN ID and a 4G-GUTI that is associated with the latest PLMN ID.

### User Equipment (UE)

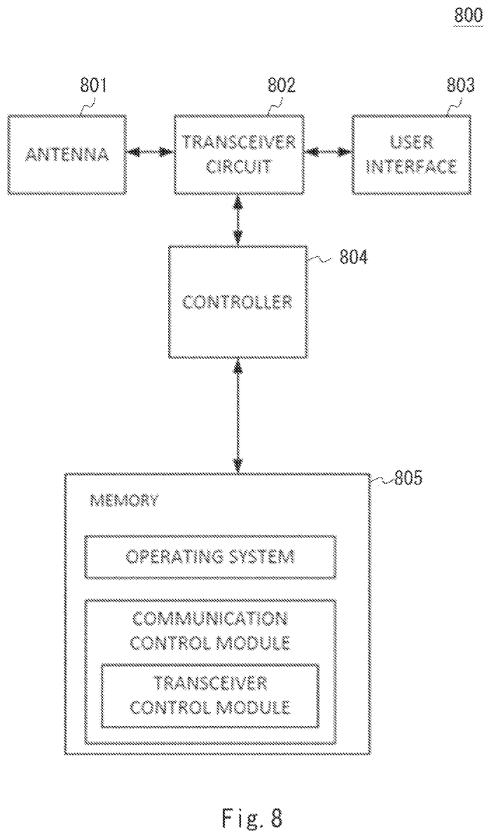

FIG. 8 is a block diagram illustrating the main components of the UE(800). As shown, the UE(800) includes a transceiver circuit(802) which is operable to transmit signals to and to receive signals from the connected node(s) via one or more antenna(801). Although not necessarily shown in FIG. 8, the UE will of course have all the usual functionality of a conventional mobile device (such as a user interface) and this may be provided by any one or any combination of hardware, software and firmware, as appropriate. Software may be pre-installed in the memory and/or may be downloaded via the telecommunication network or from a removable data storage device (RMD), for example.

A controller(804) controls the operation of the UE in accordance with software stored in a memory(805). The software includes, among other things, an operating system and a communications control module having at least a transceiver control module. The communications control module (using its transceiver control sub-module) is responsible for handling (generating/sending/receiving) signalling and uplink/downlink data packets between the UE and other nodes, such as the base station/(R)AN node, the MME, the AMF (and other core network nodes). Such signalling may include, for example, appropriately formatted signalling messages relating to connection establishment and maintenance (e.g. RRC connection establishment and other RRC messages), periodic location update related messages (e.g. tracking area update, paging area updates, location area update) etc. Such signalling may also include, for example, broadcast information (e.g. Master Information and System information) in a receiving case.

### (R)AN Node

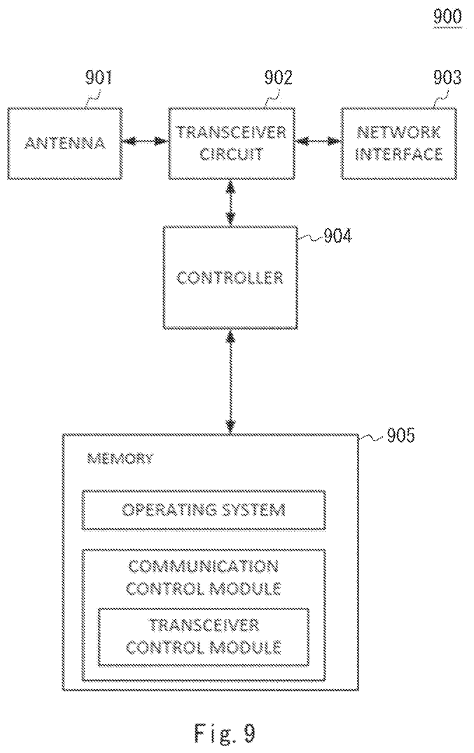

FIG. 9 is a block diagram illustrating the main components of an exemplary (R)AN node (900), for example a base station (‘eNB’ in LTE, ‘gNB’ in 5G). As shown, the (R)AN node includes a transceiver circuit (902) which is operable to transmit signals to and to receive signals from connected UE(s) via one or more antenna (901) and to transmit signals to and to receive signals from other network nodes (either directly or indirectly) via a network interface (903). A controller (904) controls the operation of the (R)AN node in accordance with software stored in a memory (905). Software may be pre-installed in the memory and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the (R)AN node and other nodes, such as the UE, the MME, the AMF(e.g. directly or indirectly). The signalling may include, for example, appropriately formatted signalling messages relating to a radio connection and location procedures (for a particular UE), and in particular, relating to connection establishment and maintenance (e.g. RRC connection establishment and other RRC messages), periodic location update related messages (e.g. tracking area update, paging area updates, location area update), S1 AP messages and NG AP messages (i.e. messages by N2 reference point), etc. Such signalling may also include, for example, broadcast information (e.g. Master Information and System information) in a sending case.

The controller (904) is also configured (by software or hardware) to handle related tasks such as, when implemented, UE mobility estimate and/or moving trajectory estimation.

### AMF

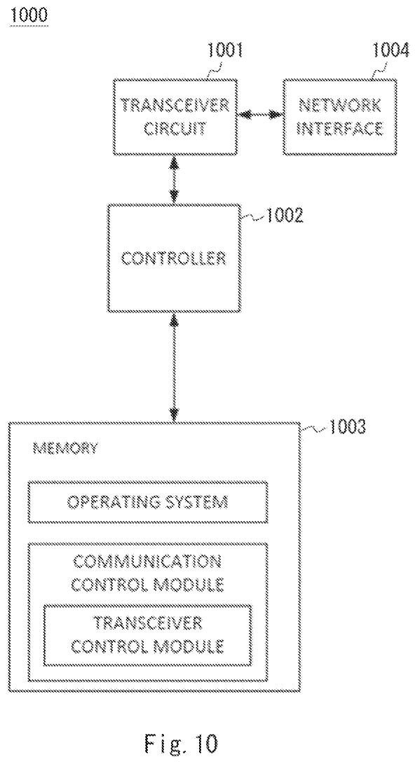

FIG. 10 is a block diagram illustrating the main components of the AMF (1000). The AMF (1000) is included in the 5GC. As shown, the AMF (1000) includes a transceiver circuit (1001) which is operable to transmit signals to and to receive signals from other nodes (including the UE) via a network interface (1004). A controller (1002) controls the operation of the AMF (1000) in accordance with software stored in a memory (1003). Software may be pre-installed in the memory (1003) and/or may be downloaded via the telecommunication network or from a removable data storage device (RMD), for example. The software includes, among other things, an operating system and a communications control module having at least a transceiver control module.

The communications control module (using its transceiver control sub-module) is responsible for handling (generating/sending/receiving) signalling between the AMF and other nodes, such as the UE, base station/(R)AN node (e.g. “gNB” or “eNB”) (directly or indirectly). Such signalling may include, for example, appropriately formatted signalling messages relating to the procedures described herein, for example, NG AP message (i.e. a message by N2 reference point) to convey an NAS message from and to the UE, etc.

The User Equipment (or “UE”, “mobile station”, “mobile device” or “wireless device”) in the present disclosure is an entity connected to a network via a wireless interface. It should be noted that the UE in this specification is not limited to a dedicated communication device, and can be applied to any device, having a communication function as a UE described in this specification, as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “UE” and “wireless device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies. Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE may support one or more IoT or MTC applications. Some examples of MTC applications are listed in the Table 3 (source: 3GPP TS 22.368, Annex B, the contents of which are incorporated herein by reference). This list is not exhaustive and is intended to be indicative of some examples of machine type communication applications.

TABLE 1
Some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

The whole or part of the example embodiments disclosed above can be described as, but not limited to, the following.

### 6.1.3 Authentication Procedures

### 6.1.3.1 Authentication Procedure for EAP-AKA′

EAP-AKA′ is specified in RFC 5448 [12]. The 3GPP 5G profile for EAP-AKA′ is specified in the normative Annex F.

Editor's Note: The reference to RFC 5448 will be superseded by the internet draft referred to in when it becomes an RFC.

The selection of using EAP-AKA′ is described in sub-clause 6.1.2 of the present document.

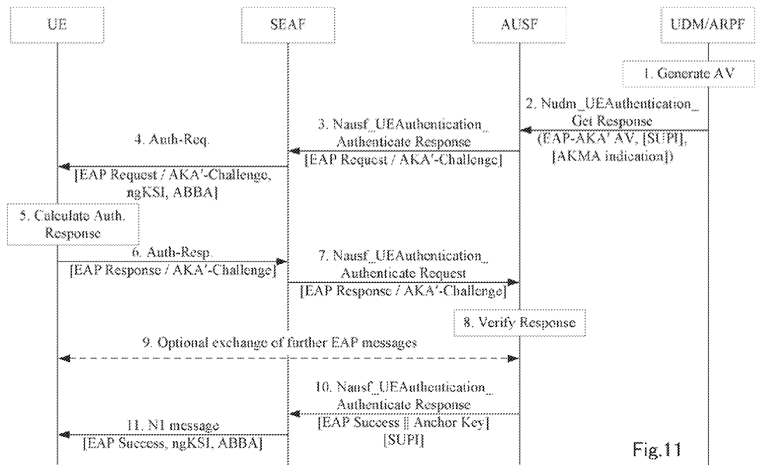

FIG. 6.1.3.1-1: Authentication procedure for EAP-AKA′ (See FIG. 11 of the present application.)

The authentication procedure for EAP-AKA′ works as follows, cf. also FIG. 6.1.3.1-1 (See FIG. 11 of the present application):
1. The UDM/ARPF shall first generate an authentication vector with Authentication Management Field (AMF) separation bit=1 as defined in TS 33.102 [9]. The UDM/ARPF shall then compute CK′ and IK′ as per the normative Annex A and replace CK and IK by CK′ and IK′.
2. The UDM shall subsequently send this transformed authentication vector AV′ (RAND, AUTN, XRES, CK′, IK′) to the AUSF from which it received the Nudm_UEAuthentication_Get Request together with an indication that the AV′ is to be used for EAP-AKA′ using a Nudm_UEAuthentication_Get Response message.

NOTE: The exchange of a Nudm_UEAuthentication_Get Request message and an Nudm_UEAuthentication_Get Response message between the AUSF and the UDM/ARPF described in the preceding paragraph is the same as for trusted access using EAP-AKA′ described in TS 33.402 [11], sub-clause 6.2, step 10, except for the input parameter to the key derivation, which is the value of <network name>.

The “network name” is a concept from RFC 5448 [12]; it is carried in the AT_KDF_INPUT attribute in EAP-AKA′. The value of <network name>parameter is not defined in RFC 5448 [12], but rather in 3GPP specifications. For EPS, it is defined as “access network identity” in TS 24.302 [71], and for 5G, it is defined as “serving network name” in sub-clause 6.1.1.4 of the present document.

In case SUCI was included in the Nudm_UEAuthentication_Get Request, UDM will include the SUPI in the Nudm_UEAuthentication_Get Response.

The AUSF and the UE shall then proceed as described in RFC 5448 [12] until the AUSF is ready to send the EAP-Success.

If a subscriber has an AKMA subscription, the UDM shall include the AKMA indication in the Nudm_UEAuthentication_Get Response.
3. The AUSF shall send the EAP-Request/AKA′-Challenge message to the SEAF in a Nausf_UEAuthentication_Authenticate Response message.
4. The SEAF shall transparently forward the EAP-Request/AKA′-Challenge message to the UE in a NAS message Authentication Request message. The ME shall forward the RAND and AUTN received in EAP-Request/AKA′-Challenge message to the USIM. This message shall include the ngKSI and ABBA parameter. In fact, SEAF shall include the ngKSI and ABBA parameter in all EAP-Authentication request message. ngKSI will be used by the UE and AMF to identify the partial native security context that is created if the authentication is successful. The SEAF shall set the ABBA parameter as defined in Annex A.7.1. During an EAP authentication, the value of the ngKSI and the ABBA parameter sent by the SEAF to the UE shall not be changed. When an Xn handover has been completed successfully to a new serving network during the authentication procedure, the AMF shall include SN name sent in the Nausf_UEAuthentication_Authenticate Request message in the Authentication Request message.

NOTE 1: The SEAF needs to understand that the authentication method used is an EAP method by evaluating the type of authentication method based on the Nausf_UEAuthentication_Authenticate Response message.
5. At receipt of the RAND and AUTN, the USIM shall verify the freshness of the AV′ by checking whether AUTN can be accepted as described in TS 33.102 [9]. If so, the USIM computes a response RES. The USIM shall return RES, CK, IK to the ME. If the USIM computes a Kc (i.e. GPRS Kc) from CK and IK using conversion function c3 as described in TS 33.102 [9], and sends it to the ME, then the ME shall ignore such GPRS Kc and not store the GPRS Kc on USIM or in ME. The ME shall derive CK′ and IK′ according to Annex A.3. When the UE receives the SN name in the authentication request message then the UE shall use the SN name to calculate RES and K_{AUSF}.

If the verification of the AUTN fails on the USIM, then the USIM and ME shall proceed as described in sub-clause 6.1.3. 3.
6. The UE shall send the EAP-Response/AKA′-Challenge message to the SEAF in a NAS message Auth-Resp message.
7. The SEAF shall transparently forward the EAP-Response/AKA′-Challenge message to the AUSF in Nausf_UEAuthentication_Authenticate Request message.
8. The AUSF shall verify the message, and if the AUSF has successfully verified this message it shall continue as follows, otherwise it shall return an error to the SEAF. AUSF shall inform UDM about the authentication result (see sub-clause 6.1.4 of the present document for details on linking authentication confirmation).
9. The AUSF and the UE may exchange EAP-Request/AKA′-Notification and EAP-Response/AKA′-Notification messages via the SEAF. The SEAF shall transparently forward these messages.

NOTE 2: EAP Notifications as described in RFC 3748 [27] and EAP-AKA Notifications as described in RFC 4187 [21] can be used at any time in the EAP-AKA exchange. These notifications can be used e.g. for protected result indications or when the EAP server detects an error in the received EAP-AKA response.
10. The AUSF derives EMSK from CK′ and IK′ as described in RFC 5448[12] and Annex F. The AUSF uses the most significant 256 bits of EMSK as the K_{AUSF} and then calculates K_{SEAF} from K_{AUSF} as described in clause A.6. The AUSF shall send an EAP Success message to the SEAF inside Nausf_UEAuthentication_Authenticate Response, which shall forward it transparently to the UE. Nausf_UEAuthentication_Authenticate Response message contains the K_{SEAF}. If the AUSF received a SUCI from the SEAF when the authentication was initiated (see sub-clause 6.1.2 of the present document), then the AUSF shall also include the SUPI in the Nausf_UEAuthentication_Authenticate Response message.

NOTE 3: For lawful interception, the AUSF sending SUPI to SEAF is necessary but not sufficient. By including the SUPI as input parameter to the key derivation of K_{AMF} from K_{SEAF}, additional assurance on the correctness of SUPI is achieved by the serving network from both, home network and UE side.
11. The SEAF shall send the EAP Success message to the UE in the N1 message. This message shall also include the ngKSI and the ABBA parameter. The SEAF shall set the ABBA parameter as defined in Annex A.7.1.

NOTE 4: Step 11 could be NAS Security Mode Command or Authentication Result.

NOTE 5: The ABBA parameter is included to enable the bidding down protection of security features that may be introduced later.

The key received in the Nausf_UEAuthentication_Authenticate Response message shall become the anchor key, K_{SEAF} in the sense of the key hierarchy in sub-clause 6.2 of the present document. The SEAF shall then derive the K_{AMF} from the K_{SEAF}, the ABBA parameter and the SUPI according to Annex A.7 and send it to the AMF. On receiving the EAP-Success message, the UE derives EMSK from CK′ and IK′ as described in RFC 5448 and Annex F. The ME uses the most significant 256 bits of the EMSK as the K_{AUSF} and then calculates K_{SEAF} in the same way as the AUSF. The UE shall derive the K_{AMF} from the K_{SEAF}, the ABBA parameter and the SUPI according to Annex A.7.

NOTE 6: As an implementation option, the UE creates the temporary security context as described in step 11 after receiving the EAP message that allows EMSK to be calculated. The UE turns this temporary security context into a partial security context when it receives the EAP Success. The UE removes the temporary security context if the EAP authentication fails.

The further steps taken by the AUSF upon receiving a successfully verified EAP-Response/AKA′-Challenge message are described in sub-clause 6.1.4 of the present document.

If the EAP-Response/AKA′-Challenge message is not successfully verified, the subsequent AUSF behaviour is determined according to the home network's policy.

If AUSF and SEAF determine that the authentication was successful, then the SEAF provides the ngKSI and the K_{AMF} to the AMF.

### 6.1.3.2 Authentication Procedure for 5G AKA

### 6.1.3.2.0 5G AKA

5G AKA enhances EPS AKA [10] by providing the home network with proof of successful authentication of the UE from the visited network. The proof is sent by the visited network in an Authentication Confirmation message.

The selection of using 5G AKA is described in sub-clause 6.1.2 of the present document.

NOTE 1: 5G AKA does not support requesting multiple 5G AVs, neither the SEAF pre-fetching 5G AVs from the home network for future use.

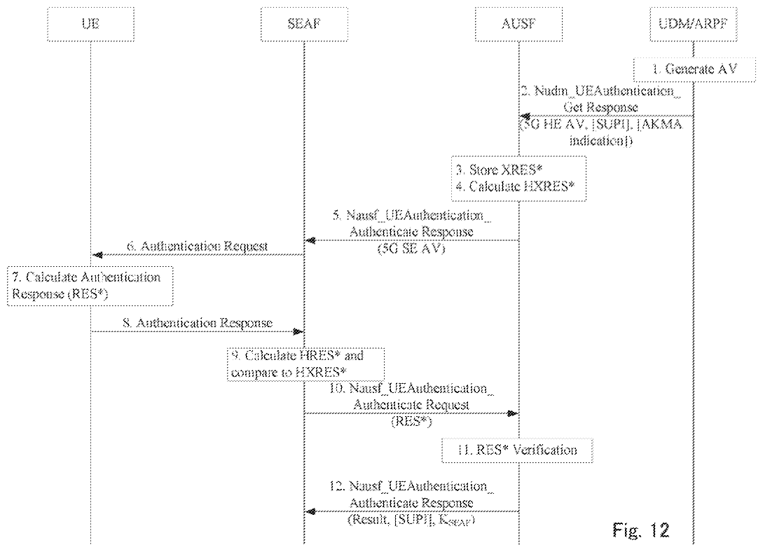

FIG. 6.1.3.2-1: Authentication procedure for 5G AKA (See FIG. 12 of the present application.)

The authentication procedure for 5G AKA works as follows, cf. also FIG. 6.1.3.2-1 (See FIG. 12 of the present application.):
1. For each Nudm Authenticate Get Request, the UDM/ARPF shall create a 5G HE AV. The UDM/ARPF does this by generating an AV with the Authentication Management Field (AMF) separation bit set to “1” as defined in TS 33.102 [9]. The UDM/ARPF shall then derive K_{AUSF} (as per Annex A.2) and calculate XRES* (as per Annex A.4). Finally, the UDM/ARPF shall create a 5G HE AV from RAND, AUTN, XRES*, and K_{AUSF}.
2. The UDM shall then return the 5G HE AV to the AUSF together with an indication that the 5G HE AV is to be used for 5G AKA in a Nudm_UEAuthentication_Get Response. In case SUCI was included in the Nudm_UEAuthentication_Get Request, UDM will include the SUPI in the Nudm_UEAuthentication_Get Response after deconcealment of SUCI by SIDF.

If a subscriber has an AKMA subscription, the UDM shall include the AKMA indication in the Nudm_UEAuthentication_Get Response.
3. The AUSF shall store the XRES* temporarily together with the received SUCI or SUPI.
4. The AUSF shall then generate the 5G AV from the 5G HE AV received from the UDM/ARPF by computing the HXRES* from XRES* (according to Annex A.5) and K_{SEAF} from K_{AUSF}(according to Annex A.6), and replacing the XRES* with the HXRES* and K_{AUSF} with K_{SEAF} in the 5G HE AV.
5. The AUSF shall then remove the K_{SEAF} and return the 5G SE AV (RAND, AUTN, HXRES*) to the SEAF in a Nausf_UEAuthentication_Authenticate Response.
6. The SEAF shall send RAND, AUTN to the UE in a NAS message Authentication Request. This message shall also include the ngKSI that will be used by the UE and AMF to identify the K_{AMF} and the partial native security context that is created if the authentication is successful. This message shall also include the ABBA parameter. The SEAF shall set the ABBA parameter as defined in Annex A.7.1. When an Xn handover has been completed successfully to a new serving network during the authentication procedure, the AMF shall include SN name sent in the Nausf_UEAuthentication_Authenticate Request message in the Authentication Request message. The ME shall forward the RAND and AUTN received in NAS message Authentication Request to the USIM.

NOTE 2: The ABBA parameter is included to enable the bidding down protection of security features.
7. At receipt of the RAND and AUTN, the USIM shall verify the freshness of the received values by checking whether AUTN can be accepted as described in TS 33.102[9]. If so, the USIM computes a response RES. The USIM shall return RES, CK, IK to the ME. If the USIM computes a Kc (i.e. GPRS Kc) from CK and IK using conversion function c3 as described in TS 33.102 [9], and sends it to the ME, then the ME shall ignore such GPRS Kc and not store the GPRS Kc on USIM or in ME. The ME then shall compute RES* from RES according to Annex A.4. The ME shall calculate K_{AUSF} from CK∥IK according to clause A.2. The ME shall calculate K_{SEAF} from K_{AUSF} according to clause A.6. An ME accessing 5G shall check during authentication that the “separation bit” in the AMF field of AUTN is set to 1. The “separation bit” is bit 0 of the AMF field of AUTN. When the UE receives the SN name in the authentication request message then the UE shall use the SN name to calculate RES and K_{AUSF}.

NOTE 3: This separation bit in the AMF field of AUTN cannot be used anymore for operator specific purposes as described by TS 33.102 [9], Annex F.
8. The UE shall return RES* to the SEAF in a NAS message Authentication Response.
9. The SEAF shall then compute HRES* from RES* according to Annex A.5, and the SEAF shall compare HRES* and HXRES*. If they coincide, the SEAF shall consider the authentication successful from the serving network point of view. If not, the SEAF proceed as described in sub-clause 6.1.3.2.2. If the UE is not reached, and the RES* is never received by the SEAF, the SEAF shall consider authentication as failed, and indicate a failure to the AUSF.
10. The SEAF shall send RES*, as received from the UE, in a Nausf_UEAuthentication_Authenticate Request message to the AUSF.
11. When the AUSF receives as authentication confirmation the Nausf_UEAuthentication_Authenticate Request message including a RES* it may verify whether the 5G AV has expired. If the 5G AV has expired, the AUSF may consider the authentication as unsuccessful from the home network point of view. Upon successful authentication, the AUSF shall store the K_{AUSF}. AUSF shall compare the received RES* with the stored XRES*. If the RES* and XRES* are equal, the AUSF shall consider the authentication as successful from the home network point of view. AUSF shall inform UDM about the authentication result (see sub-clause 6.1.4 of the present document for linking with the authentication confirmation).
12. The AUSF shall indicate to the SEAF in the Nausf_UEAuthentication_Authenticate Response whether the authentication was successful or not from the home network point of view. If the authentication was successful, the K_{SEAF} shall be sent to the SEAF in the Nausf_UEAuthentication_Authenticate Response. In case the AUSF received a SUCI from the SEAF in the authentication request (see sub-clause 6.1.2 of the present document), and if the authentication was successful, then the AUSF shall also include the SUPI in the Nausf_UEAuthentication_Authenticate Response message.

If the authentication was successful, the key K_{SEAF} received in the Nausf_UEAuthentication_Authenticate Response message shall become the anchor key in the sense of the key hierarchy as specified in sub-clause 6.2 of the present document. Then the SEAF shall derive the K_{AMF} from the K_{SEAF}, the ABBA parameter and the SUPI according to Annex A.7. The SEAF shall provide the ngKSI and the K_{AMF} to the AMF.

If a SUCI was used for this authentication, then the SEAF shall only provide ngKSI and K_{AMF} to the AMF after it has received the Nausf_UEAuthentication_Authenticate Response message containing K_{SEAF} and SUPI; no communication services will be provided to the UE until the SUPI is known to the serving network.

The further steps taken by the AUSF after the authentication procedure are described in sub-clause 6.1.4 of the present document.

### 6.1.3 Authentication Procedures

### 6.1.3.1 Authentication Procedure for EAP-AKA′

EAP-AKA′ is specified in RFC 5448 [12]. The 3GPP 5G profile for EAP-AKA′ is specified in the normative Annex F.

Editor's Note: The reference to RFC 5448 will be superseded by the internet draft referred to in [67] when it becomes an RFC.

The selection of using EAP-AKA′ is described in sub-clause 6.1.2 of the present document.

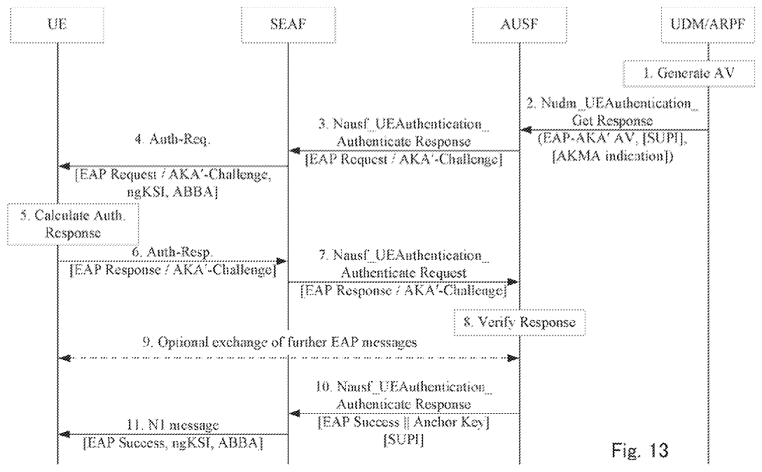

FIG. 6.1.3.1-1: Authentication procedure for EAP-AKA′ (See FIG. 13 of the present application.)

The authentication procedure for EAP-AKA′ works as follows, cf. also FIG. 6.1.3.1-1 (See FIG. 13 of the present application.):
1. The UDM/ARPF shall first generate an authentication vector with Authentication Management Field (AMF) separation bit=1 as defined in TS 33.102 [9]. The UDM/ARPF shall then compute CK′ and IK′ as per the normative Annex A and replace CK and IK by CK′ and IK′.
2. The UDM shall subsequently send this transformed authentication vector AV′ (RAND, AUTN, XRES, CK′, IK′) to the AUSF from which it received the Nudm_UEAuthentication_Get Request together with an indication that the AV′ is to be used for EAP-AKA′ using a Nudm_UEAuthentication_Get Response message.

NOTE: The exchange of a Nudm_UEAuthentication_Get Request message and an Nudm_UEAuthentication_Get Response message between the AUSF and the UDM/ARPF described in the preceding paragraph is the same as for trusted access using EAP-AKA′ described in TS 33.402 [11], sub-clause 6.2, step 10, except for the input parameter to the key derivation, which is the value of <network name>. The “network name” is a concept from RFC 5448 [12]; it is carried in the AT_KDF_INPUT attribute in EAP-AKA′. The value of <network name> parameter is not defined in RFC 5448 [12], but rather in 3GPP specifications. For EPS, it is defined as “access network identity” in TS 24.302 [71], and for 5G, it is defined as “serving network name” in sub-clause 6.1.1.4 of the present document.

In case SUCI was included in the Nudm_UEAuthentication_Get Request, UDM will include the SUPI in the Nudm_UEAuthentication_Get Response.

The AUSF and the UE shall then proceed as described in RFC 5448 [12] until the AUSF is ready to send the EAP-Success.

If a subscriber has an AKMA subscription, the UDM shall include the AKMA indication in the Nudm_UEAuthentication_Get Response.
3. The AUSF shall send the EAP-Request/AKA′-Challenge message to the SEAF in a Nausf_UEAuthentication_Authenticate Response message.
4. The SEAF shall transparently forward the EAP-Request/AKA′-Challenge message to the UE in a NAS message Authentication Request message. The ME shall forward the RAND and AUTN received in EAP-Request/AKA′-Challenge message to the USIM. This message shall include the ngKSI and ABBA parameter. In fact, SEAF shall include the ngKSI and ABBA parameter in all EAP-Authentication request message. ngKSI will be used by the UE and AMF to identify the partial native security context that is created if the authentication is successful. The SEAF shall set the ABBA parameter as defined in Annex A.7.1. During an EAP authentication, the value of the ngKSI and the ABBA parameter sent by the SEAF to the UE shall not be changed. When an Xn handover has been completed successfully during the authentication procedure, the AMF shall include SN name corresponding to the current serving network in the Authentication Request message. When the SEAF determines that the Xn handover has been taken place successfully to a new serving network during the ongoing authentication procedure. The AMF shall abort the current ongoing authentication procedure and initiates a new authentication procedure and uses the new serving network name in the new authentication procedure.

NOTE 1: The SEAF needs to understand that the authentication method used is an EAP method by evaluating the type of authentication method based on the Nausf_UEAuthentication_Authenticate Response message.
5. At receipt of the RAND and AUTN, the USIM shall verify the freshness of the AV′ by checking whether AUTN can be accepted as described in TS 33.102 [9]. If so, the USIM computes a response RES. The USIM shall return RES, CK, IK to the ME. If the USIM computes a Kc (i.e. GPRS Kc) from CK and IK using conversion function c3 as described in TS 33.102 [9], and sends it to the ME, then the ME shall ignore such GPRS Kc and not store the GPRS Kc on USIM or in ME. The ME shall derive CK′ and IK′ according to Annex A.3. When the UE receives the SN name in the authentication request message then the UE shall use the SN name to calculate RES and K_{AUSF}.

If the verification of the AUTN fails on the USIM, then the USIM and ME shall proceed as described in sub-clause 6.1.3. 3.
6. The UE shall send the EAP-Response/AKA′-Challenge message to the SEAF in a NAS message Auth-Resp message.
7. The SEAF shall transparently forward the EAP-Response/AKA′-Challenge message to the AUSF in Nausf_UEAuthentication_Authenticate Request message.
8. The AUSF shall verify the message, and if the AUSF has successfully verified this message it shall continue as follows, otherwise it shall return an error to the SEAF. AUSF shall inform UDM about the authentication result (see sub-clause 6.1.4 of the present document for details on linking authentication confirmation).
9. The AUSF and the UE may exchange EAP-Request/AKA′-Notification and EAP-Response/AKA′-Notification messages via the SEAF. The SEAF shall transparently forward these messages.

NOTE 2: EAP Notifications as described in RFC 3748 [27] and EAP-AKA Notifications as described in RFC 4187 [21] can be used at any time in the EAP-AKA exchange. These notifications can be used e.g. for protected result indications or when the EAP server detects an error in the received EAP-AKA response.
10. The AUSF derives EMSK from CK′ and IK′ as described in RFC 5448[12] and Annex F. The AUSF uses the most significant 256 bits of EMSK as the K_{AUSF} and then calculates K_{SEAF} from K_{AUSF} as described in clause A.6. The AUSF shall send an EAP Success message to the SEAF inside Nausf_UEAuthentication_Authenticate Response, which shall forward it transparently to the UE. Nausf_UEAuthentication_Authenticate Response message contains the K_{SEAF}. If the AUSF received a SUCI from the SEAF when the authentication was initiated (see sub-clause 6.1.2 of the present document), then the AUSF shall also include the SUPI in the Nausf_UEAuthentication_Authenticate Response message.

NOTE 3: For lawful interception, the AUSF sending SUPI to SEAF is necessary but not sufficient. By including the SUPI as input parameter to the key derivation of K_{AMF} from K_{SEAF}, additional assurance on the correctness of SUPI is achieved by the serving network from both, home network and UE side.
11. The SEAF shall send the EAP Success message to the UE in the N1 message. This message shall also include the ngKSI and the ABBA parameter. The SEAF shall set the ABBA parameter as defined in Annex A.7.1.

NOTE 4: Step 11 could be NAS Security Mode Command or Authentication Result.

NOTE 5: The ABBA parameter is included to enable the bidding down protection of security features that may be introduced later.

The key received in the Nausf_UEAuthentication_Authenticate Response message shall become the anchor key, K_{SEAF} in the sense of the key hierarchy in sub-clause 6.2 of the present document. The SEAF shall then derive the K_{AMF} from the K_{SEAF}, the ABBA parameter and the SUPI according to Annex A.7 and send it to the AMF. On receiving the EAP-Success message, the UE derives EMSK from CK′ and IK′ as described in RFC 5448 and Annex F. The ME uses the most significant 256 bits of the EMSK as the K_{AUSF} and then calculates K_{SEAF} in the same way as the AUSF. The UE shall derive the K_{AMF} from the K_{SEAF}, the ABBA parameter and the SUPI according to Annex A.7.

NOTE 6: As an implementation option, the UE creates the temporary security context as described in step 11 after receiving the EAP message that allows EMSK to be calculated. The UE turns this temporary security context into a partial security context when it receives the EAP Success. The UE removes the temporary security context if the EAP authentication fails.

The further steps taken by the AUSF upon receiving a successfully verified EAP-Response/AKA′-Challenge message are described in sub-clause 6.1.4 of the present document.

If the EAP-Response/AKA′-Challenge message is not successfully verified, the subsequent AUSF behaviour is determined according to the home network's policy.

If AUSF and SEAF determine that the authentication was successful, then the SEAF provides the ngKSI and the K_{AMF} to the AMF.

### 6.1.3.2 Authentication Procedure for 5G AKA

### 6.1.3.2.0 5G AKA

5G AKA enhances EPS AKA [10] by providing the home network with proof of successful authentication of the UE from the visited network. The proof is sent by the visited network in an Authentication Confirmation message.

The selection of using 5G AKA is described in sub-clause 6.1.2 of the present document.

NOTE 1: 5G AKA does not support requesting multiple 5G AVs, neither the SEAF pre-fetching 5G AVs from the home network for future use.

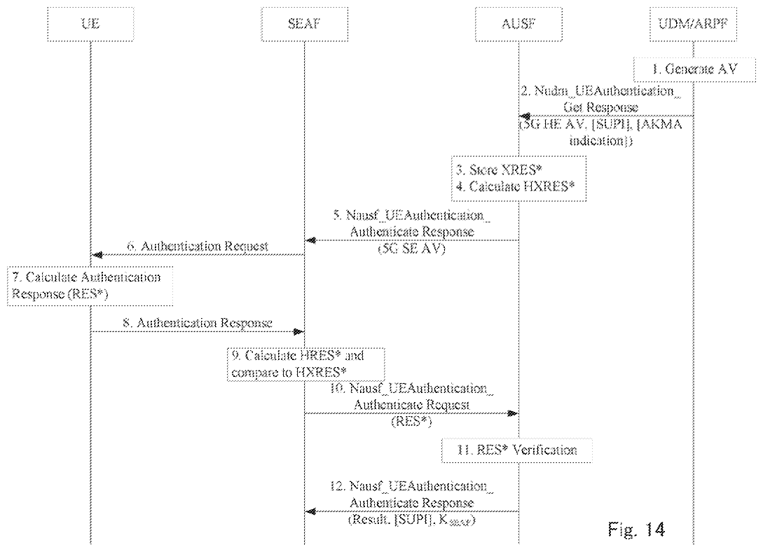

### FIG. 6.1.3.2-1: Authentication procedure for 5G AKA (See FIG. 14 of the present application.)

The authentication procedure for 5G AKA works as follows, cf. also FIG. 6.1.3.2-1 (See FIG. 14 of the present application.):
1. For each Nudm_Authenticate_Get Request, the UDM/ARPF shall create a 5G HE AV. The UDM/ARPF does this by generating an AV with the Authentication Management Field (AMF) separation bit set to “1” as defined in TS 33.102 [9]. The UDM/ARPF shall then derive K_{AUSF} (as per Annex A.2) and calculate XRES* (as per Annex A.4). Finally, the UDM/ARPF shall create a 5G HE AV from RAND, AUTN, XRES*, and K_{AUSF}.
2. The UDM shall then return the 5G HE AV to the AUSF together with an indication that the 5G HE AV is to be used for 5G AKA in a Nudm_UEAuthentication_Get Response. In case SUCI was included in the Nudm_UEAuthentication_Get Request, UDM will include the SUPI in the Nudm_UEAuthentication_Get Response after deconcealment of SUCI by SIDF. If a subscriber has an AKMA subscription, the UDM shall include the AKMA indication in the Nudm_UEAuthentication_Get Response.
3. The AUSF shall store the XRES* temporarily together with the received SUCI or SUPI.
4. The AUSF shall then generate the 5G AV from the 5G HE AV received from the UDM/ARPF by computing the HXRES* from XRES* (according to Annex A.5) and K_{SEAF} from K_{AUSF} (according to Annex A.6), and replacing the XRES* with the HXRES* and K_{AUSF} with K_{SEAF} in the 5G HE AV.
5. The AUSF shall then remove the K_{SEAF} and return the 5G SE AV (RAND, AUTN, HXRES*) to the SEAF in a Nausf_UEAuthentication_Authenticate Response.
6. The SEAF shall send RAND, AUTN to the UE in a NAS message Authentication Request. This message shall also include the ngKSI that will be used by the UE and AMF to identify the K_{AMF} and the partial native security context that is created if the authentication is successful. This message shall also include the ABBA parameter. The SEAF shall set the ABBA parameter as defined in Annex A.7.1. When an Xn handover has been completed successfully during the authentication procedure, the AMF shall include SN name corresponding to the current serving network in the Authentication Request message. The ME shall forward the RAND and AUTN received in NAS message Authentication Request to the USIM. When the SEAF determines that the Xn handover has been taken place successfully to a new serving network during the ongoing authentication procedure. The AMF shall abort the current ongoing authentication procedure and initiates a new authentication procedure and uses the new serving network name in the new authentication procedure.

NOTE 2: The ABBA parameter is included to enable the bidding down protection of security features.
7. At receipt of the RAND and AUTN, the USIM shall verify the freshness of the received values by checking whether AUTN can be accepted as described in TS 33.102[9]. If so, the USIM computes a response RES. The USIM shall return RES, CK, IK to the ME. If the USIM computes a Kc (i.e. GPRS Kc) from CK and IK using conversion function c3 as described in TS 33.102 [9], and sends it to the ME, then the ME shall ignore such GPRS Kc and not store the GPRS Kc on USIM or in ME. The ME then shall compute RES* from RES according to Annex A.4. The ME shall calculate K_{AUSF} from CK∥IK according to clause A.2. The ME shall calculate K_{SEAF} from K_{AUSF} according to clause A.6. An ME accessing 5G shall check during authentication that the “separation bit” in the AMF field of AUTN is set to 1. The “separation bit” is bit 0 of the AMF field of AUTN. When the UE receives the SN name in the authentication request message then the UE shall use the SN name to calculate RES and K_{AUSF}.

NOTE 3: This separation bit in the AMF field of AUTN cannot be used anymore for operator specific purposes as described by TS 33.102 [9], Annex F.
8. The UE shall return RES* to the SEAF in a NAS message Authentication Response.
9. The SEAF shall then compute HRES* from RES* according to Annex A.5, and the SEAF shall compare HRES* and HXRES*. If they coincide, the SEAF shall consider the authentication successful from the serving network point of view. If not, the SEAF proceed as described in sub-clause 6.1.3.2.2. If the UE is not reached, and the RES* is never received by the SEAF, the SEAF shall consider authentication as failed, and indicate a failure to the AUSF.
10. The SEAF shall send RES*, as received from the UE, in a Nausf_UEAuthentication_Authenticate Request message to the AUSF.
11. When the AUSF receives as authentication confirmation the Nausf_UEAuthentication_Authenticate Request message including a RES* it may verify whether the 5G AV has expired. If the 5G AV has expired, the AUSF may consider the authentication as unsuccessful from the home network point of view. Upon successful authentication, the AUSF shall store the K_{AUSF}. AUSF shall compare the received RES* with the stored XRES*. If the RES* and XRES* are equal, the AUSF shall consider the authentication as successful from the home network point of view. AUSF shall inform UDM about the authentication result (see sub-clause 6.1.4 of the present document for linking with the authentication confirmation).
12. The AUSF shall indicate to the SEAF in the Nausf_UEAuthentication_Authenticate Response whether the authentication was successful or not from the home network point of view. If the authentication was successful, the K_{SEAF} shall be sent to the SEAF in the Nausf_UEAuthentication_Authenticate Response. In case the AUSF received a SUCI from the SEAF in the authentication request (see sub-clause 6.1.2 of the present document), and if the authentication was successful, then the AUSF shall also include the SUPI in the Nausf_UEAuthentication_Authenticate Response message.

If the authentication was successful, the key K_{SEAF} received in the Nausf_UEAuthentication_Authenticate Response message shall become the anchor key in the sense of the key hierarchy as specified in sub-clause 6.2 of the present document. Then the SEAF shall derive the K_{AMF} from the K_{SEAF}, the ABBA parameter and the SUPI according to Annex A.7. The SEAF shall provide the ngKSI and the K_{AMF} to the AMF.

If a SUCI was used for this authentication, then the SEAF shall only provide ngKSI and K_{AMF} to the AMF after it has received the Nausf_UEAuthentication_Authenticate Response message containing K_{SEAF} and SUPI; no communication services will be provided to the UE until the SUPI is known to the serving network.

The further steps taken by the AUSF after the authentication procedure are described in sub-clause 6.1.4 of the present document.

### ABBREVIATIONS

For the purposes of the present document, the abbreviations given in TR 21.905 [1] and the following apply. An abbreviation defined in the present document takes precedence over the definition of the same abbreviation, if any, in TR 21.905 [1].

4G-GUTI 4G Globally Unique Temporary UE Identity

5GC 5G Core Network

5GLAN 5G Local Area Network

5GS 5G System

5G-AN 5G Access Network

5G-AN PDB 5G Access Network Packet Delay Budget

5G-EIR 5G-Equipment Identity Register

5G-GUTI 5G Globally Unique Temporary Identifier

5G-BRG 5G Broadband Residential Gateway

5G-CRG 5G Cable Residential Gateway

5G GM 5G Grand Master

5G-RG 5G Residential Gateway

5G-S-TMSI 5G S-Temporary Mobile Subscription Identifier

5G VN 5G Virtual Network

5QI 5G QoS Identifier

AF Application Function

AMF Access and Mobility Management Function

AS Access Stratum

ATSSS Access Traffic Steering, Switching, Splitting

ATSSS-LL ATSSS Low-Layer

AUSF Authentication Server Function

AUTN Authentication token

BMCA Best Master Clock Algorithm

BSF Binding Support Function

CAG Closed Access Group

CAPIF Common API Framework for 3GPP northbound APIs

CHF Charging Function

CN PDB Core Network Packet Delay Budget

CP Control Plane

DAPS Dual Active Protocol Stacks

DL Downlink

DN Data Network

DNAI DN Access Identifier

DNN Data Network Name

DRX Discontinuous Reception

DS-TT Device-side TSN translator

ePDG evolved Packet Data Gateway

EBI EPS Bearer Identity

EPS Evolved Packet System

EUI Extended Unique Identifier

FAR Forwarding Action Rule

FN-BRG Fixed Network Broadband RG

FN-CRG Fixed Network Cable RG

FN-RG Fixed Network RG

FQDN Fully Qualified Domain Name

GFBR Guaranteed Flow Bit Rate

GMLC Gateway Mobile Location Centre

GPSI Generic Public Subscription Identifier

GUAMI Globally Unique AMF Identifier

GUTI Globally Unique Temporary UE Identity

HR Home Routed (roaming)

IAB Integrated access and backhaul

IMEI/TAC IMEI Type Allocation Code

IPUPS Inter PLMN UP Security

I-SMF Intermediate SMF

I-UPF Intermediate UPF

LADN Local Area Data Network

LBO Local Break Out (roaming)

LMF Location Management Function

LoA Level of Automation

LPP LTE Positioning Protocol

LRF Location Retrieval Function

MCC Mobile country code

MCX Mission Critical Service

MDBV Maximum Data Burst Volume

MFBR Maximum Flow Bit Rate

MICO Mobile Initiated Connection Only

MNC Mobile Network Code

MPS Multimedia Priority Service

MPTCP Multi-Path TCP Protocol

N3IWF Non-3GPP InterWorking Function

N5CW Non 5G-Capable over WLAN

NAI Network Access Identifier

NEF Network Exposure Function

NF Network Function

NGAP Next Generation Application Protocol

NID Network identifier

NPN Non-Public Network

NR New Radio

NRF Network Repository Function

NSI ID Network Slice Instance Identifier

NSSAA Network Slice-Specific Authentication and Authorization

NSSAAF Network Slice-Specific Authentication and Authorization Function

NSSAI Network Slice Selection Assistance Information

NSSF Network Slice Selection Function

NSSP Network Slice Selection Policy

NW-TT Network-side TSN translator

NWDAF Network Data Analytics Function

PCF Policy Control Function

PDB Packet Delay Budget

PDR Packet Detection Rule

PDU Protocol Data Unit

PEI Permanent Equipment Identifier

PER Packet Error Rate

PFD Packet Flow Description

PNI-NPN Public Network Integrated Non-Public Network

PPD Paging Policy Differentiation

PPF Paging Proceed Flag

PPI Paging Policy Indicator

PSA PDU Session Anchor

PTP Precision Time Protocol

QFI QoS Flow Identifier

QoE Quality of Experience

RACS Radio Capabilities Signalling optimisation

(R)AN (Radio) Access Network

RG Residential Gateway

RIM Remote Interference Management

RQA Reflective QoS Attribute

RQI Reflective QoS Indication

RSN Redundancy Sequence Number

SA NR Standalone New Radio

SBA Service Based Architecture

SBI Service Based Interface

SCP Service Communication Proxy

SD Slice Differentiator

SEAF Security Anchor Functionality

SEPP Security Edge Protection Proxy

SMF Session Management Function

SMSF Short Message Service Function

SN Sequence Number

SN name Serving Network Name

SNPN Stand-alone Non-Public Network

S-NSSAI Single Network Slice Selection Assistance Information

SSC Session and Service Continuity

SSCMSP Session and Service Continuity Mode Selection Policy

SST Slice/Service Type

SUCI Subscription Concealed Identifier

SUPI Subscription Permanent Identifier

SV Software Version

TNAN Trusted Non-3GPP Access Network

TNAP Trusted Non-3GPP Access Point

TNGF Trusted Non-3GPP Gateway Function

TNL Transport Network Layer

TNLA Transport Network Layer Association

TSC Time Sensitive Communication

TSCAI TSC Assistance Information

TSN Time Sensitive Networking

TSN GM TSN Grand Master

TSP Traffic Steering Policy

TT TSN Translator

TWIF Trusted WLAN Interworking Function

UCMF UE radio Capability Management Function

UDM Unified Data Management

UDR Unified Data Repository

UDSF Unstructured Data Storage Function

UL Uplink

UL CL Uplink Classifier

UPF User Plane Function

URLLC Ultra Reliable Low Latency Communication

URRP-AMF UE Reachability Request Parameter for AMF

URSP UE Route Selection Policy

VID VLAN Identifier

VLAN Virtual Local Area Network

W-5GAN Wireline 5G Access Network

W-5GBAN Wireline BBF Access Network

W-5GCAN Wireline 5G Cable Access Network

W-AGF Wireline Access Gateway Function

### Definitions

For the purposes of the present document, the terms and definitions given in 3GPP TR 21.905 [1] and the following apply. A term defined in the present document takes precedence over the definition of the same term, if any, in 3GPP TR 21.905 [1].

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian patent application No. 202011047284, filed on Oct. 29, 2020, the disclosure of which is incorporated herein in its entirety by reference.

### REFERENCE SIGNS LIST

800 UE

801 antenna

802 transceiver circuit

803 user interface

804 controller

805 memory

900 (R)AN node

901 antenna

902 transceiver circuit

903 network interface

904 controller

905 memory

1000 AMF

1001 transceiver circuit

1002 controller

1003 memory

1004 network interface

What is claimed is:

1. A method of a communication apparatus comprising:
performing a registration procedure to a first Public Land Mobile Network (PLMN) for a user equipment (UE);
sending a first message to perform an authentication for the UE,
wherein the first message includes an identifier of the first PLMN;
performing a handover procedure with a change from the first PLMN to a second PLMN for the UE;
receiving a second message,
wherein the second message includes the identifier of the first PLMN; and
sending an authentication request message to the UE,
wherein the authentication request message includes the identifier of the first PLMN.

2. The method according to claim 1, further comprising:
receiving a third message indicating that the authentication is completed; and
sending an identifier of the second PLMN to a Unified Data Management (UDM) to update the identifier of the first PLMN.

3. A method of a user equipment (UE) comprising:
performing a registration procedure to a first Public Land Mobile Network (PLMN);
performing a handover procedure with a change from the first PLMN to a second PLMN;
receiving an authentication request message,
wherein the authentication request message includes an identifier of the first PLMN; and
performing an authentication procedure based on the identifier of the first PLMN.

4. A communication apparatus comprising:
a memory; and
at least one hardware processor coupled to the memory,
wherein the at least one hardware processor is configured to:
perform a registration procedure to a first Public Land Mobile Network (PLMN) for a user equipment (UE),
send a first message to perform an authentication for the UE,
wherein the first message includes an identifier of the first PLMN;
perform a handover procedure with a change from the first PLMN to a second PLMN for the UE;
receive a second message,
wherein the second message includes the identifier of the first PLMN; and
send an authentication request message to the UE,
wherein the authentication request message includes the identifier of the first PLMN.

5. (canceled)

6. A user equipment (UE) comprising:
a memory; and
at least one hardware processor coupled to the memory,
wherein the at least one hardware processor is configured to:
perform a registration procedure to a first Public Land Mobile Network (PLMN);
perform a handover procedure with a change from the first PLMN to a second PLMN;
receive an authentication request message,
wherein the authentication request message includes an identifier of the first PLMN; and
perform an authentication procedure based on the identifier of the first PLMN.

7.-20. (canceled)

21. The method according to claim 3, further comprising
checking whether a Mobile Country Code (MCC) and a Mobile Network Code (MNC) of an identifier of the second PLMN are same to a MCC and a MNC of a 5G Globally Unique Temporary Identifier (5G-GUTI) in case where the UE has the 5G-GUTI; and
performing the authentication procedure based on the MCC and the MNC of the 5G-GUTI in a case where the MCC and the MNC of the identifier of the second PLMN are not same to the MCC and the MNC of the 5G-GUTI.

22. (canceled)

23. The method according to claim 1, further comprising:
receiving a third message including an identifier of the second PLMN; and
checking whether a Mobile Country Code (MCC) and a Mobile Network Code (MNC) of the identifier of the second PLMN are same to a MCC and a MNC of a 5G Globally Unique Temporary Identifier (5G-GUTI) in case where the communication apparatus has the 5G-GUTI; and
sending a fourth message to authenticate the UE in a case where the MCC and the MNC of the identifier of the second PLMN are not same to the MCC and the MNC of the 5G-GUTI,
wherein the fourth message includes the identifier of the second PLMN.

24.-28. (canceled)
